(19) United States
(12) Patent Application Publication
(10) Pub. No.: US 2004/0237069 A1
(43) Pub. Date: Nov. 25, 2004

(54) Creation of a script for executing commands

(75) Inventor: John Colgrave, Hampshire (GB)

Correspondence Address: David R. Irvin, IBM Corp. IP Law Dept T81/503, 3039 Cornwallis Road., PO Box 12195, Research Triangle Park, NC, 27709-2195, US

(73) Assignee: International Business Machines Corporation, Armonk, NY

(21) Appl. No.: 10/702,375

(22) Filed: Nov. 5, 2003

(30) Foreign Application Priority Data
May 23, 2003 (GB) 0311868.4

(51) Int. Cl. G06F 9/44

(52) U.S. Cl. 717/115

(57) ABSTRACT

The present invention provides a method for a scripting tool, a scripting tool, and computer program product which carries out a method for a scripting tool, to create a script for executing a sequence of commands. The scripting tool receives and processes a sequence of commands and then receives an indication of one of a plurality of scripting languages. Based on this information the tool then creates a script, in the scripting language indicated, containing the sequence of commands. The script may then be run in an execution environment which supports that scripting language and is independent of the scripting tool.

### FIELD OF THE INVENTION

The present invention relates to scripting tools and more particularly to tools which enable a user to create a script for executing a defined sequence of commands.

### BACKGROUND TO THE INVENTION

Frequently when administering or accessing a software product a user may execute a series of commands or actions which request the software product to perform certain functions, for example, to configure the software product or obtain information about its configuration. For example, when configuring a software product the user may use commands to define such things as the identity of users with permission to access the product and applications which are made available through the product. Similarly commands may be executed to obtain information about the users or applications defined to the product. Further as the same series of commands may need to be executed against several instances of the software product or a series of commands need to be executed frequently to obtain information from the software product, it is common to write a script containing the commands. A script is a software program in a scripting language which, when executed, executes the commands defined within it. Taking this one step further the software product may also provide a tool, such as a graphical tool, which can be used to execute commands against the product and further automatically produce a script, containing the commands, which can be executed subsequently in conjunction with the tool.

For example a product such as IBM® DB2® provides a tool with the ability to create and execute scripts which, for example, define tables to the database or obtain details of tables defined to the database.

In another example, in relation to Web Services, a Universal Description Discovery and Integration (UDDI) registry is defined which accepts Simple Object Access Protocol (SOAP) requests. The UDDI registry is used by web services to register the services which they provide and by clients to obtain details of one or more web services which provide the services which they wish to use. As a result an administrator may provide to client machines a script containing actions which, when executed, result in requests being sent to a UDDI registry to obtain details of a web service which is appropriate for the client to use. For example a company may provide a script to employees for obtaining details from a UDDI registry of web services which the company prefers its employees to use, for example as provided by a particular provider. However such a script requires an execution tool which, on execution of the script, converts the commands defined in the script to appropriate SOAP requests which the registry recognises.

In environments such as web services the commands and interfaces supported by the various components are generally defined by a standards body such that all products which implement a standards defined component support the same sets of commands and interfaces. The UDDI registry is one such component which is defined by UDDI.org and supports a client interface specified by the UDDI.org based on SOAP requests. As a result it is possible for one provider to provide a tool which can be used to create and execute scripts which result in SOAP requests which are sent to the UDDI registry of another provider.

However, the current set of scripting tools are somewhat restrictive as they are limited to creating scripts in a specific scripting language and further the scripts must be executed within the tool used to create them.

### SUMMARY OF THE INVENTION

Accordingly, according to a first aspect the present invention provides a method for a scripting tool to create a script, the method comprising the steps of: receiving a sequence of commands for execution; receiving an indication of one of a plurality of scripting languages; outputting a script in the indicated scripting language, the script containing the sequence of commands.

According to a second aspect the present invention provides a scripting tool for creating a script, the tool comprising: means for receiving a sequence of commands for execution; means for receiving an indication of one of a plurality of scripting languages; means for outputting a script in the indicated scripting language, the script containing the sequence of commands.

According to a third aspect the present invention provides a computer program product comprising instructions which, when executed on a data processing host, cause the data processing host to carry out the method according to the first aspect.

Thus, according to the present invention a scripting tool is provided which can create scripts in a plurality of languages. In a preferred embodiment the scripting tool supports a plurality of scripting languages from which a user may choose to generate a script which contains a user defined sequence of commands. As a result, advantageously the user may generate a script in a preferred language, for example based on the knowledge of the person who will maintain the script, and further to match an execution environment in which the user wishes to execute the script and in which the script can be run independently of the tool used to create it.

Preferably each command in the sequence of commands is executed before generating the script. This enables a user to check that the requested command is valid before generating a script containing the command. Further results from each command may be provided to the user so that the user may use the results when selecting a subsequent command in the sequence.

The sequence of commands could be for performing actions in any product which accepts commands, for example a database product or a Universal Data Directory Interface (UDDI) registry.

### BRIEF DESCRIPTION OF THE DRAWINGS

The invention will now be described, by way of example only, with reference to a preferred embodiment thereof, as illustrated in the accompanying drawings, in which:

FIG. 1 is a block diagram of a data processing environment in which the preferred embodiment of the present invention can be advantageously applied;

FIG. 2 is a schematic diagram which shows a scripting tool for generating scripts to run against a UDDI registry according to the preferred embodiment of the present invention; and

FIG. 3 is a flow chart of the method followed by the scripting tool of FIG. 2 when generating a script.

### DESCRIPTION OF THE PREFERRED EMBODIMENT

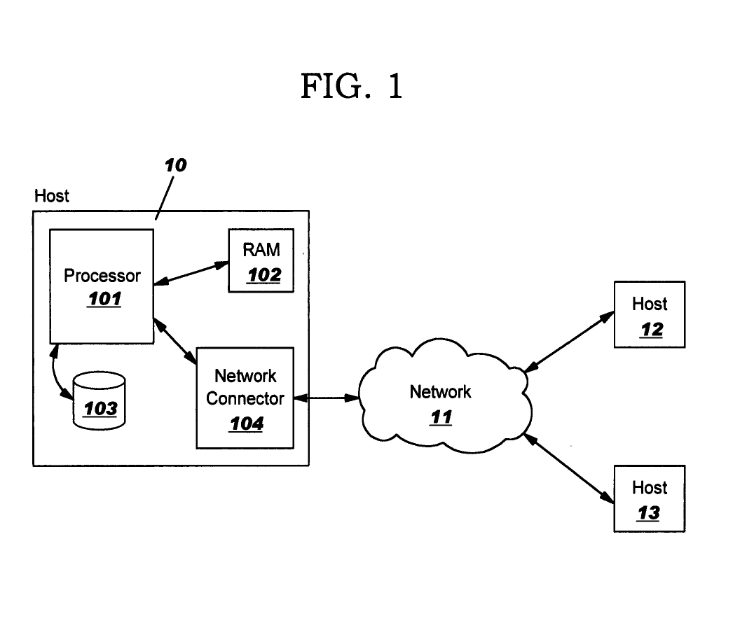

In FIG. 1, a client/server data processing host 10 is connected to other client/server data processing host 12 and 13 via a network 11, which could be, for example, the Internet. In the preferred embodiment a UDDI registry may be installed on any such client/server and accept requests to define details of a web service or obtain details of a web service from the same or another client/server data processing host. Client/server 10 has a processor 101 for executing programs that control the operation of the client/server 10, a RAM volatile memory element 102, a non-volatile memory 103, and a network connector 104 for use in interfacing with the network 11 for communication with the other client/servers 12 and 13.

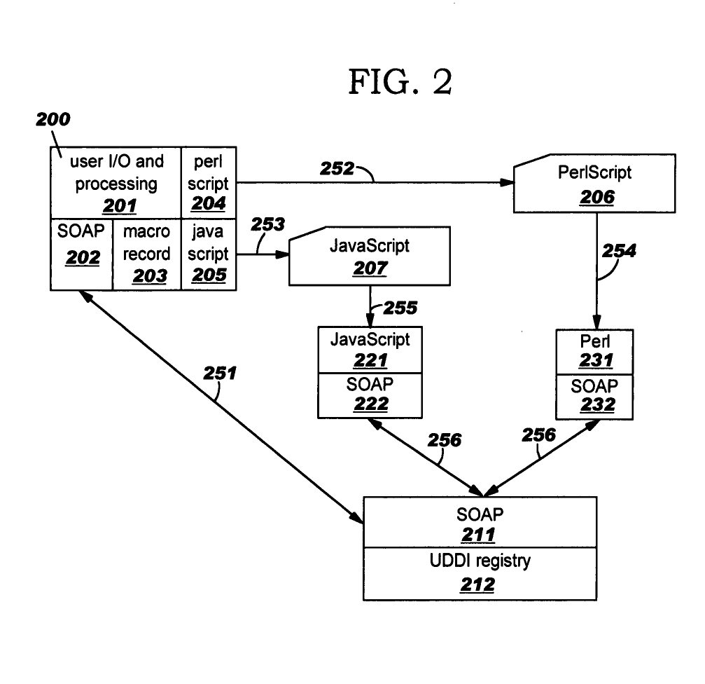

FIG. 2 is a schematic diagram which shows a scripting tool which can create scripts for performing actions against a UDDI registry according to the preferred embodiment of the present invention. The scripting tool 200 provides a graphical interface which enables a user to define and execute actions which result in SOAP requests being sent to a UDDI registry. The tool includes a user input/output and processing component 201 which accepts and processes user requests to execute actions and reports results of executed actions to the user. The user i/o and processing component further accepts user inputs which specify that a script is to be created and indication of a scripting language to be used when creating the script. The tool further includes a SOAP component 202 which is used by the user i/o and processing component to access (251) the UDDI registry 212 via the registry SOAP component 211. A user with a task to complete specifies to the user i/o and processing component an action to be executed against the UDDI registry, which the tool does by converting the action to an appropriate SOAP request and sending it to the UDDI registry. A response is then received from the UDDI registry for which the scripting tool reports the result back to the user. Depending on the result the user may then define and execute one or more further requests until the task to be completed is finished. The user then indicates that the task is complete. During this process a macro record component 203 maintains a record of the sequence of actions the user executed and so, when the user indicates that the task is complete, the user i/o and processing component asks the user if a script containing the recorded sequence of actions should be created. The user is further given a choice of scripting language for the script to be created. In the preferred embodiment the languages available are PerlScript and JavaScript. If the user chooses PerlScript a PerlScript engine 204 is used to generate a script 205 in the PerlScript language, and if the user chooses JavaScript script a JavaScript engine 206 is used to generate a script 207 in the JavaScript language.

As a simple example, a user may want to access a UDDI registry to obtain details of all web services which match a certain criteria and then select one from those returned. For example if the user wishes to obtain details of all web services which began with the string “IBM” they may request the tool to perform an action which results in a SOAP request of the form:

<?xml version=“1.0” encoding=“UTF-8” ?>
<Envelope xmlns=“http://schemas.xmlsoap.org/soap/envelope/”>
<Body>
<find_business generic=“2.0” xmlns=“urn:uddi-org:api_v2”>
<findQualifiers>
<findQualifier>caseSensitiveMatch</findQualifler>
</findQualifiers>
<name>IBM</name>
</find_business>
</Body>
</Envelope>

This request might return a plurality of web services, for example, each with a different key. A key, for example, could identify a particular provider and as a result the user can select a favoured provider and further request the tool to perform an action to obtain more details of the web service of a favoured provider. This may result in a SOAP message being sent to the UDDI registry of the form:

<?xml version=“1.0” encoding=“UTF-8” ?>
<Envelope xmlns=“http://schemas.xmlsoap.org/soap/envelope/”>
<Body>
<get_businessDetail generic=“2.0” xmlns=“urn:uddi-org:api_v2”>
<businessKey>11E5AE0F-230C-4889-8E0D-023F</businessKey>
</get_businessDetail>
</Body>
</Envelope>

Once these two actions have been completed the user indicates that the task is complete and is then given the choice of creating a script which can be used to repeat the sequence of actions. For example if the user decides to generate a JavaScript script the tool may output a script of the form:

. . .
var findBizReq = new FindBusinessRequest();
findBizReq.addName(“IBM”);
findBizReq.addFindQualifier(-37 caseSensitiveMatch”);
. . .
var businessList = preoxy.find_business(findBizReq);
. . .
var getBusinessDetailReq = new GetBusinessDetailRequest();
getBusinessDetailReq.addBusinessKey(“11E5AE0F-230C-4889-
8E0D-023F”);
var businessDetail = proxy.get_businessDetail(getBusinessDetailReq);

Alternatively, for example, if the user decides to generate a PerlScript script the tool may output a script of the form:

#!/usr/bin/perl
$findBizReq = CreateBean(“org.uddi4j.adapt.FindBusinessRequest”);
$findBizReq->addName(“IBM”);
$findBizReq->addFindQualifier(“caseSensitiveMatch”);
. . .
$businessList = $proxy->find_business($findBizReq);
. . .
$getBusinessDetailRequest =
CreateBean(“org.uddi4j.adapt.GetBusinessDetailRequest”);
$getBusinessDetailRequest->addBusinessKey(“11E5AE0F-230C-
4889-8E0D-023F”);
$businessDetail =
proxy->get_businessDetail($getBusinessDetailRequest);

A created script may then be run using an appropriate tool which is independent of the tool used to create the script. Returning to FIG. 2, the PerlScript script 206 may subsequently be executed (254) using an execution tool which provides a PerlScript engine 231. Alternatively the JavaScript script 207 may subsequently be run on an execution tool which provides a JavaScript engine 221. In both cases the appropriate engine converts each action in the script into a SOAP request for sending (256) to the UDDI registry 212.

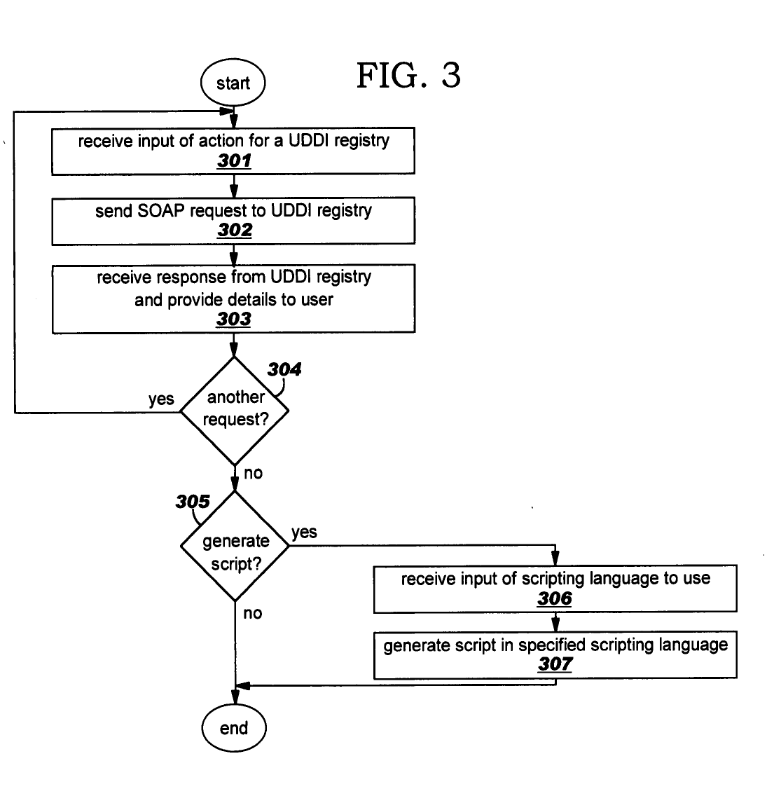

FIG. 3 shows the method steps which are followed by the scripting tool 201 of FIG. 2, according to the preferred embodiment of the present invention. At step 301 the tool receives an action to run against a UDDI registry. During the first pass through step 301 the action is the first of a sequence of actions which complete a task to be performed with a UDDI registry. The scripting tool keeps a record of the action requested before creating an appropriate SOAP request and sending it to the UDDI registry at step 302, and receiving a response to the request action at step 303 details of which are provided to the user. At step 304 a check is made to see if the user has another action to input as part of the sequence of actions and if so processing returns to step 301 where the next action is received. However, if the sequence is complete, the user is offered the chance to create a script and at step 305 the user response is checked. If the user wants to create a script the user is given the chance to indicate which of a plurality of scripting languages is to be used and at step 306 an indication of the scripting language chosen is received. Finally at step 307 a script is created in the language chosen. The generated script may then be executed outside of the scripting tool that produced it and as a result the same sequence of actions can be executed in a “batch” or “command-line” environment, or any environment that supports the particular scripting language.

Note that whilst the tool of the preferred embodiment only supports JavaScript and PerlScript scripts in another embodiment is could support more or different scripting languages such as NetRexx, Bean Markup Language (BML), JACL Adventure Creation Language, Jython, Python, VBScript, Jscript and PerlScript.

Further note that a skilled person would realise that the method described in FIG. 3 could be implemented in a variety of programming languages, for example, Java™, C, and C++ (Java and all Java-based trademarks are trademarks of Sun Microsystems, Inc. in the United States, other countries, or both). Further a skilled person would realise that once implemented the methods can be stored in a computer program product comprising or more programs, in source or executable form, on a media, such as floppy disk, CD, and DVD, suitable for loading onto a data processing host and causing the data processing host to carry out the methods.

Thus the present invention provides a method for a scripting tool, a scripting tool, and computer program product which carries out a method for a scripting tool, to create a script for executing a sequence of commands. The scripting tool receives and processes a sequence of commands and then receives an indication of one of a plurality of scripting languages. Based on this information the tool then creates a script, in the scripting language indicated, containing the sequence of commands. The script may then be run in an execution environment which supports that scripting language and is independent of the scripting tool. In a preferred embodiment the scripting tool receives and processes a sequence of commands as specified by a user and then enables the user to choose one of a plurality of scripting languages such that when tool creates a script containing the sequence of commands the script is created in the language chosen by the user.

I claim:

1. A method for a scripting tool to create a script, the method comprising the steps of:
receiving a sequence of commands to perform;
receiving an indication of one of a plurality of scripting languages;
outputting a script in the indicated scripting language, the script containing the sequence of user requested commands.

2. A method according to claim 1 comprising the further step of:
executing each command in the sequence of commands prior to outputting the script.

3. A method according to claim 2 comprising the further step of:
providing details of the response from execution of each command to a user.

4. A method according to claim 1 wherein the commands are to be executed against a Universal Data Directory Interface (UDDI) registry.

5. A method according to claim 1 wherein the plurality of scripting languages include at least two from JavaScript, NetRexx, Bean Markup Language (BML), JACL Adventure Creation Language, Jython, Python, VBScript, JScript and PerlScript.

6. A scripting tool for creating a script, the tool comprising:
means for receiving a sequence of commands to perform;
means for receiving an indication of one of a plurality of scripting languages;
means for outputting a script in the indicated scripting language, the script containing the sequence of commands.

7. A scripting tool according to claim 6 further comprising:
means for executing each command in the sequence of commands prior to outputting the script.

8. A scripting tool according to claim 7 further comprising:
means for providing details of the response from execution of each command to a user.

9. A scripting tool according to claim 6 wherein the commands are to be executed against a Universal Data Directory Interface (UDDI) registry.

10. A scripting tool according to claim 6 wherein the plurality of scripting languages include at least two from JavaScript, NetRexx, Bean Markup Language (BML), JACL Adventure Creation Language, Jython, Python, VBScript, JScript and PerlScript.

11. A computer program product comprising instructions which, when executed on a data processing host, cause the data processing host to cany out a method comprising the steps:
receiving a sequence of commands to perform;
receiving an indication of one of a plurality of scripting languages;
outputting a script in the indicated scripting language, the script containing the sequence of user requested commands.

12. A computer program product according to claim 11 wherein the method comprises the further step of:
executing each command in the sequence of commands prior to outputting the script.

13. A computer program product according to claim 12 wherein the method comprises the further step of:
providing details of the response from execution of each command to a user.

14. A computer program product according to claim 11 wherein the commands are to be executed against a Universal Data Directory Interface (UDDI) registry.

15. A computer program product according to claim 11 wherein the plurality of scripting languages include at least two from JavaScript, NetRexx, Bean Markup Language (BML), JACL Adventure Creation Language, Jython, Python, VBScript, JScript and PerlScript.
